(19) United States
(12) Patent Application Publication
(10) Pub. No.: US 2024/0128545 A1
(43) Pub. Date: Apr. 18, 2024

(54) COOLING MODULE FOR BATTERIES OF AN ELECTRIC OR HYBRID VEHICLE

(71) Applicant: BorgWarner lnc., Auburn Hills, MI (US)

(72) Inventors: Christian Kroisleitner, Friedberg (AT); Román Carballido, Vigo (ES); Lidia María Fontán Martinez, Vigo (ES); Óscar Abelairas, Vigo (ES); Francisco Lozano, O Porriño (ES)

(21) Appl. No.: 18/483,369

(22) Filed: Oct. 9, 2023

(30) Foreign Application Priority Data
Oct. 17, 2022 (EP) 22 202 009.1
Feb. 15, 2023 (EP) 23 156 886.6

(51) Int. Cl. H01M 10/6568; H01M 10/613; H01M 10/625; H01M 10/6557

(52) U.S. Cl. CPC H01M 10/6568; H01M 10/613; H01M 10/625; H01M 10/6557; B60K 11/02; H01M 2220/20

(57) ABSTRACT

A cooling module for batteries of an electric or hybrid vehicle that has a coolant supply line, a coolant discharge line, and flat tubes arranged side by side, between which there is space for batteries to be cooled. Each of the flat tubes is connected to the coolant supply line and the coolant discharge line. The flat tubes each carry connectors and the coolant supply line and the coolant discharge line are each assembled from a plurality of line segments connected by a connector of one of the flat tubes to one of the connectors of an adjacent flat tube.

### RELATED APPLICATIONS

This application claims priority to EP 23 156 886.6, filed Feb. 15, 2023, and EP 22 202 009.1, filed Oct. 17, 2022, the entire disclosures of both of which are hereby incorporated herein by reference.

### BACKGROUND

This disclosure relates to a cooling module for batteries of an electric or hybrid vehicle.

Batteries of electric or hybrid vehicles must be cooled during operation with coolant, usually an aqueous liquid. At low temperatures, the coolant may also be heated and thus used to heat up the batteries.

### SUMMARY

This disclosure teaches a cooling module for batteries of electric or hybrid vehicles that is inexpensive to manufacture and can be adapted to the number of batteries, or battery cells, of an electric or hybrid vehicle with little effort.

A cooling module according to this disclosure has a coolant supply line, a coolant discharge line, and a plurality of flat tubes arranged side by side, between which there is space for the batteries that are to be cooled, and which are attached to the coolant supply line and the coolant discharge line. The individual flat tubes can thus, located in parallel with one another, be connected to the coolant supply line and the coolant discharge line, and may run at right angles to the coolant supply line and the coolant discharge line. According to this disclosure, the flat tubes each have connectors, and the coolant supply line and the coolant discharge line are each assembled from a plurality of line segments, each of which connects a connector of one of the flat tubes to a connector of an adjacent flat tube. The line segments may be formed by the connectors or line segments may be separate parts in addition to the connectors.

In this way, the number of flat tubes of a cooling module and thus the number of spaces for the batteries that are to be cooled, can be adapted to vehicle manufacturers' requirements with little effort.

Depending on the shape of the batteries, or battery cells, the flat tubes can be of corrugated or planar design. Corrugated flat tubes are particularly suitable for cylindrical batteries, while flat tubes of planar design are particularly suitable for cuboid batteries, or battery cells. The batteries can, for example, be adhesively bonded onto the flat tubes, or attached to them in some other way. In the case of cuboid shaped batteries flat tubes may be used that touch not only a front side or a back side of batteries, but additionally also part of a lateral side. The flat tubes may be bent correspondingly, for example.

The flat tubes may be made inexpensively of plastic. Another option is to make the flat tubes from metal, for example, from an aluminium alloy, with which an improved thermal coupling of the coolant to the batteries, or battery cells, can be achieved.

Flat tubes made from metal can be produced, for example, as extruded sections, which may be deformed, for example, corrugated, after extrusion.

In an advantageous refinement of this disclosure, provision is made for the connectors to be attached to end pieces, which are attached to ends of the flat tubes. Such end pieces may be attached to the flat tubes, for example, by means of a push-fit connection or a plug-in connection. Alternatively or additionally, a materially bonded connection can be used, for example, in the form of adhesive bonding, soldering, brazing or welding. Connectors may be formed integrally with the end pieces, or may be attached to the end pieces as separate components, for example, by means of a push-fit connection or plug-in connection. Alternatively or additionally, the connectors can also be connected to the relevant end piece by means of a material bond, for example, in the form of adhesive bonding, soldering or welding.

In the cooling module, the flat tubes may run between the coolant supply line and the coolant discharge line. In this case, the flat tubes have an end piece at each of their two ends, with which they are connected by way of connectors to the coolant supply line and the coolant discharge line. Alternatively, the flat tubes may each carry at only one end an end piece with a plurality of connectors. The coolant supply line and the coolant discharge line then run at right angles to the flat tubes on the same side. In this case, each flat tube forms at least two channels running side by side, namely an outward channel and a return channel. Such a flat tube can be manufactured from the outset as an extrusion with a central web separating the two channels or a plurality of return outward channels and a plurality of return channels. Alternatively, a flat tube may also be extruded without a web and compressed in a central region in its longitudinal direction, and its top and bottom surfaces then be welded together in this central region. The end of the flat tubes not used for connection to the coolant supply line and the coolant discharge line is then closed with a deflector that connects the two channels of the flat tube. Such a deflector may be made of metal or plastic and can, for example, be connected to the flat tubes by means of a push-fit connection or a plug-in connection. Alternatively or additionally, the end piece can also be connected to the relevant flat tube by means of a material bond, for example, in the form of adhesive bonding, soldering or welding.

In an advantageous refinement of this disclosure an end piece of a flat tube may form both a connector for the coolant supply line and also a connector for the coolant discharge line. In this way, the number of parts can be reduced, and thus inexpensive production can be achieved. However, it is also possible to use a separate end piece for each of the channels of the flat tube, each of which is connected only to the coolant supply line or only to the coolant discharge line.

In an advantageous refinement of this disclosure the line segments of the coolant supply line and the coolant discharge line may be connected to the connectors by means of a push-fit connection or a plug-in connection. The connectors may be inserted into the line segments, or the line segments may be inserted into the connectors. The end pieces may carry both a connector, into which one of the line segments is inserted, and also an inner part, which projects into the line segment concerned. The inner part may carry an annular seal, for example, in an annular groove. In this way, not only can leakage be reliably prevented, but manufacturing tolerances with regard to the alignment of the components involved in the push-fit connection or plug-in connection can also be compensated for. In addition, the seal between the line segment and the inner part can be protected by the connector.

Flat tubes, which sit between flat tubes, may be designed with end pieces, which each have connectors on opposite sides for the coolant supply line and the coolant discharge line. Here it is possible for the connectors to be designed identically on both sides, for example, to be designed on both sides as a male part of a push-fit connection or plug-in connection, or designed on both sides as a female part of a push-fit connection or plug-in connection. In one configuration of this disclosure, however, it is also possible for the connectors in each case to be designed on one side of the end piece as a male part of a push-fit connection or plug-in connection, and on an opposite side of the end piece as a female part of a push-fit connection or plug-in connection. In this case it is especially advantageous if an end piece which carries connectors both for the coolant supply line and for the coolant discharge line, the end piece has on each side both a male and a female connector. An assembly of one flat tube with end pieces and connectors can then be in two different orientations, i.e., turned along its longitudinal axis by 180°, for the cooling module.

If an end piece thereby carries both connectors for segments of the coolant supply line, and also for segments of the coolant discharge line, it is also possible on each side of the end piece for both a connector for a male push-fit connection or plug-in connection, and also a connector for a female push-fit connection or plug-in connection, to be provided.

In a cooling module according to this disclosure, it is possible for batteries, or battery cells, on opposite sides to abut against one of the flat tubes. However, if such large cooling capacities are not required, it is also possible for batteries or battery cells to abut against one of the flat tubes only on one side, and on an opposite side to abut against a spacer strip, which runs between two adjacent flat tubes, and is preferably made of plastic. The spacer strip can have an extension, by which it is attached to the coolant supply line and/or the coolant discharge line. The extension may, for example, extend between the coolant supply line and the coolant discharge line. Batteries, or battery cells, may be adhesively bonded to such a spacer strip. Advantageously, the batteries can thus be mechanically fixed by the spacer strip, without impairing the thermal coupling with the flat tube opposite the spacer strip. However, it is also possible for such a spacer strip to be clamped between batteries, or battery cells. Spacer strips may also be used at an end of the cooling module such that all flat tubes are touched on both sides by batteries.

In an advantageous refinement of this disclosure, provision is made for the spacer strips to have the same thickness as the flat tubes. The thickness of a flat tube as well as the thickness of a spacer strip is to be measured between a surface facing batteries or battery cells and an opposite surface, wherein any local recesses or depressions in a surface are to be ignored on both sides. In this context, the term “the same thickness” is to be understood to mean that the thicknesses of the flat tubes and the spacer strips are identical within manufacturing tolerances. For applications in which a reduced cooling capacity is sufficient, and batteries therefore abut against a flat tube on only one side, some flat tubes are replaced by spacer strips.

As described above, this disclosure relates to a cooling module for batteries of an electric or hybrid vehicle, that is to say, a cooling module that has not yet been populated with the appropriate batteries. However, this disclosure also relates to such a cooling module with batteries, that is to say, in particular to a cooling module with a coolant supply line, a coolant discharge line, a plurality of flat tubes arranged side by side, between which the batteries that are to be cooled are arranged, and which are connected to the coolant supply line and the coolant discharge line, wherein the flat tubes in each case carry connectors, and wherein the coolant supply line and the coolant discharge line in each case are assembled from a plurality of line segments, which each connect a connector of one of the flat tubes to a connector of an adjacent flat tube. The line segments may be formed by the connectors or line segments may be separate parts in addition to the connectors.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic representation of an embodiment of a cooling module in accordance with this disclosure;

FIG. 2 shows a lateral view of the embodiment of FIG. 1;

FIG. 3 shows a sectional view to FIG. 1;

FIG. 4 shows a view of detail A of FIG. 3;

FIG. 5 shows a view of detail B of FIG. 3;

FIG. 6 shows a schematic detail of a further embodiment of a cooling module;

FIG. 7 shows a schematic cross-section of a detail of the embodiment of FIG. 6; and

FIG. 8 shows a schematic cross-section of a detail of another embodiment.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

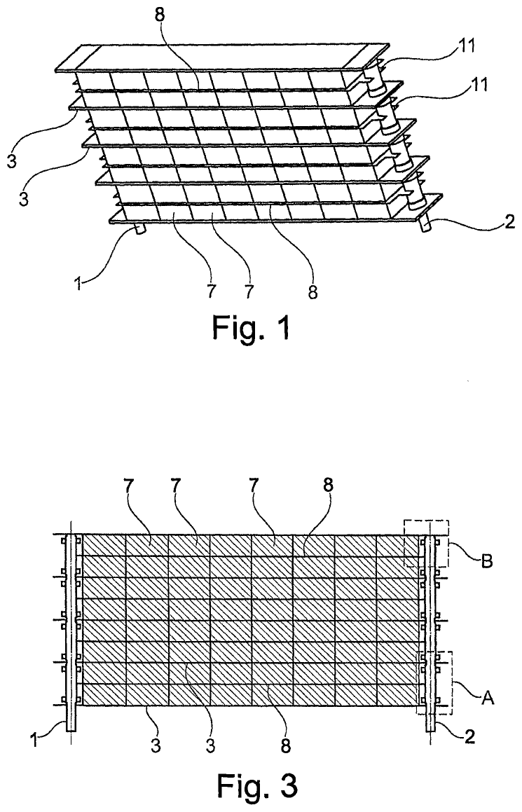

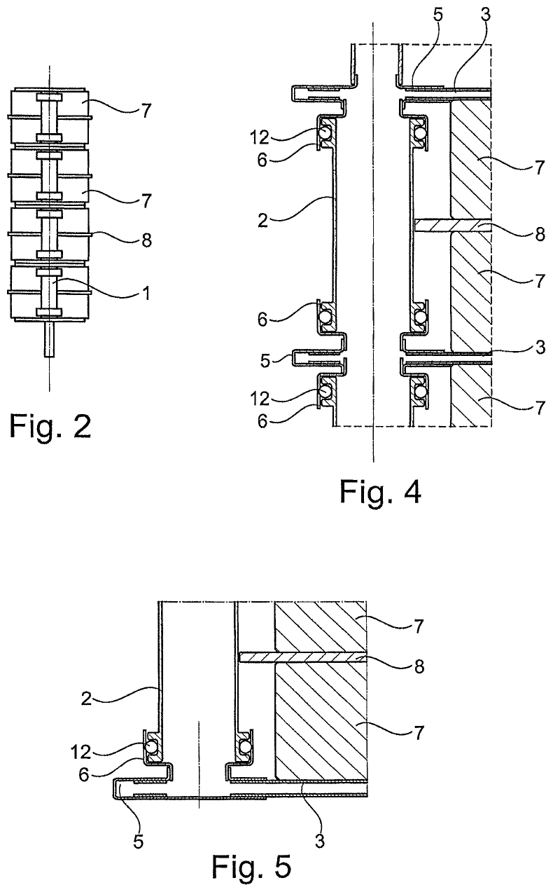

FIGS. 1 to 5 schematically show a detail of a cooling module for batteries of an electric or hybrid vehicle. The cooling module comprises a coolant supply line 1, a coolant discharge line 2, and a plurality of flat tubes 3. The flat tubes 3, located in parallel with one another, are connected to the coolant supply line 1 and the coolant discharge line 2. The flat tubes 3 run at right angles to the coolant supply line 1 and the coolant discharge line 2. Between adjacent flat tubes 3 there is space for batteries 7 to be cooled. The batteries 7 may, for example, be adhesively bonded to the sides of the flat tubes 3.

In the embodiment shown, the flat tubes 3 are of planar design, and are thus adapted to batteries 7 with a planar outer surface, for example, cuboid batteries. Alternatively, the flat tubes 3 may also be of corrugated design, for example, for circular cylindrical batteries. The flat tubes 3 can be made of metal, for example, an aluminium alloy, or plastic.

In the embodiment shown, the coolant supply line 1 and the coolant discharge line 2 are arranged at opposite ends of the flat tubes 3. The flat tubes 3 contain one or a plurality of channels extending from one end of the flat tube 3 to the opposite end. However, it is also possible that the coolant supply line 1 and the coolant discharge line 2 are arranged at the same end of the flat tubes 3. Then the flat tubes 3 contain at least two channels, namely an outward channel and a return channel. Channels can be separated in the flat tube 3 by an inner wall or a weld seam that connects the front and rear sides of a flat tube 3. If the coolant supply line 1 and the coolant discharge line 2 are at the same end of the flat tubes 3, the flat tubes 3 carry at their end facing away from the coolant supply line 1 and the coolant discharge line 2, the flat tubes 3 a deflector, not shown in the figures, which connects the outward channel with the return channel. The deflector can be connected to the flat tubes 3, for example, by means of a push-fit connection, a plug in-connection and/or a materially bonded connection, for example, in the form of brazing, welding or adhesive bonding.

The coolant supply line 1 and the coolant return line 2 are each assembled from a plurality of line segments, and are connected to the flat tubes 3 by way of connectors 6. Therein the connectors may for line segments or the connectors may connect line segments provided as separate parts. At their ends, at which the flat tubes 3 are connected to the coolant supply line 1 and the coolant return line 2, respectively, the flat tubes 3 carry an end piece 5, which is connected to the flat tubes 3 by means of a push-fit connection, a plug-in connection and/or by means of a partially bonded connection, for example, in the form of brazing, welding or adhesive bonding. The connectors 6 are attached to these end pieces 5, for example, by means of a partially bonded connection, and/or by means of a push-fit or plug-in connection.

In the embodiment shown in FIGS. 1 to 5, the line segments of the coolant supply line 1 and the coolant discharge line 2 are inserted into the connectors 6. In the connectors 6 the line segments can be surrounded by sealing rings 12, in order to compensate for tolerances in the alignment of the connectors, and to prevent leakage.

In the embodiment shown in FIGS. 1 to 5, a spacer strip 8 is arranged between adjacent flat tubes 3. In the schematically illustrated cooling module batteries 7 are then held between one of the flat tubes 3 and one of the spacer strips 8. The batteries 7 are then cooled on one side only, namely on the side that abuts against the flat tube 3 in question, while the opposite side is not cooled. This is sufficient for many cases.

The spacer strips 8 can be made inexpensively of plastic, and can be provided, for example, with an extension 11 that touches the coolant supply line 1 and/or the coolant discharge line 2, e.g., with an U-shaped extension. If the coolant supply line 1 and the coolant discharge line 2 are arranged on the same end of the flat tubes 3, the extension 11 may project between the coolant supply line 1 and the coolant discharge line 2 to facilitate positioning during assembly.

An alternative embodiment of the cooling module may also be manufactured without spacer strips. In such an alternative embodiment, batteries 7 touch flat tubes 3 on both sides and are cooled on both sides. It is also possible to arrange spacer strips 8 not between all the flat tubes 3, but instead only in an end section of the cooling module.

The cooling module can also be used to heat the batteries by passing heated coolant through the cooling module. In frosty conditions, batteries at the edge of the cooling module often have an increased heating requirement, and it can therefore be advantageous to dispense with spacer strips 8 only in an end section of the cooling module, and to arrange the flat tubes 3 at correspondingly smaller distances from one another, so that such batteries abut against flat tubes on both sides.

FIG. 4 shows detail A of FIG. 3 and FIG. 5 shows detail B of FIG. 3. FIGS. 3 to 5 show in detailed views, an end section of a flat tube 3 of the above-described cooling module, together with an end piece 5, attached to the flat tube 3 and carrying a connector 6 for purposes of connecting a line section of the coolant supply line 1 or the coolant discharge line 2.

The connector 6 surrounds an end section of a line segment of the coolant supply line 1 or the coolant discharge line 2. The line segment carries an annular seal 12, e.g., an O-ring in a groove.

It is also possible that the end piece 5 has an inner part in addition to connector 6. The connector 6 surrounds this inner part, which may carry an annular seal 10, for example, an O-ring, in an annular groove. The line section of the coolant supply line 1 or the coolant discharge line 2 then surrounds this inner part and projects into the connector 6, that is to say, it lies between the connector 6 and the inner part.

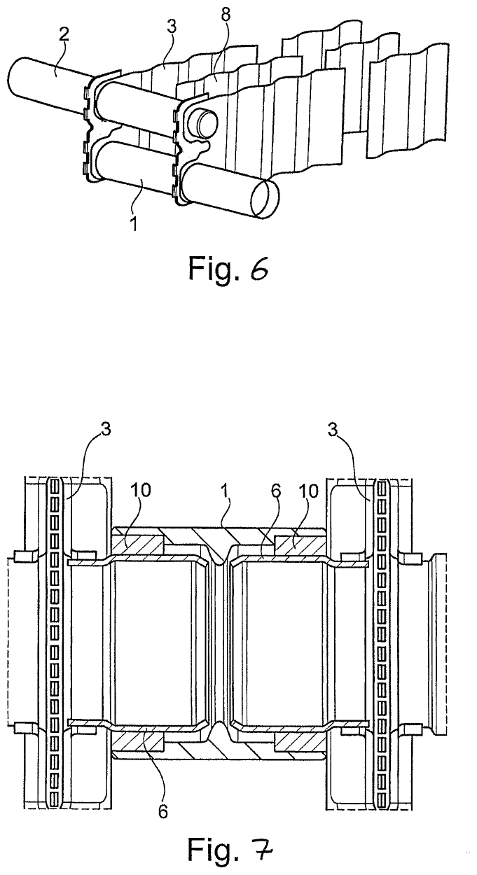

FIG. 6 shows schematically a detail of another embodiment of a cooling module comprising a coolant supply line 1, a coolant discharge line 2, a plurality of flat tubes 3, and spacer strips 8. In this embodiment both the coolant supply line 1 and the coolant discharge line 2 are arranged on the same side of the flat tubes 3. The connectors 6 arranged at one of the ends of the flat tubes 3 are stuck into the line segments of the coolant supply line 1 and the coolant discharge line 2, respectively. Hence, the line segments of the coolant supply line 1 and the coolant supply line 2 are female parts of a push-fit or plug-connection, whereas the connectors 6 are male parts of that push-fit or plug-in connection.

FIG. 6 also shows a spacer strip 8 that may or may not be used together with the segments of the coolant supply line 1, the coolant discharge line 2 and the flat tubes 3.

FIG. 7 shows a schematic cross-section of the connection of two segments of the coolant supply line 1 or the coolant supply line 2, respectively. As can be seen, connectors 6 of neighbouring flat tubes 3 are stuck into a segment of the coolant supply line 1 (or the coolant discharge line 2 which may be formed in the same way). This segment surrounds the connectors 6 and carries on an inside annular seals 10. The annular seals 10 each surround one of the connectors 6 and press against it.

In the embodiment shown in FIG. 7, a separate annular seal 10 is arranged inside the line segments for each connector 6. Alternatively, the annular seal 10 may also be a single piece that presses against both connectors 6.

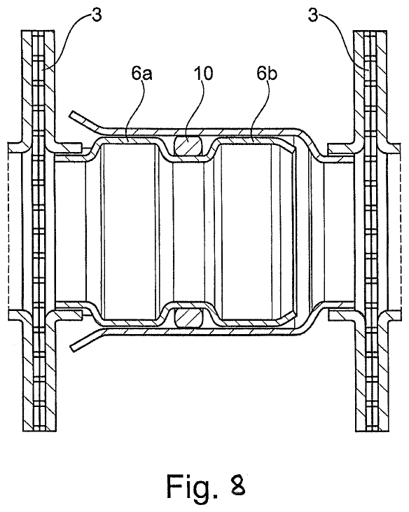

FIG. 8 shows a detail of another embodiment of a cooling module for batteries of an electric or hybrid vehicle. This embodiment differs from the embodiment of FIGS. 1 to 5 in that the supply line and the discharge line are formed from connectors of adjacent flat tubes alone. That is the connectors alone form segments of the supply line as well as the discharge and there are no spate tube segments attached to the connectors as shown, e.g., in FIG. 4.

As shown in FIG. 8, line segments of the supply line and the discharge line are formed by two connectors 6a, 6b wherein one of these connectors 6a is a male connector and the other connector 6b a female connector. The male connector 6a penetrates into the female connector 6b. An annular seal 10, e.g., an O-ring may be arranged between the male connector 6a and the female connector 6b, for example, in a groove of the male connector 6a.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 Coolant supply line
2 Coolant discharge line
3 Flat tube
5 End piece
6 Connector
7 batteries
8 Spacer strip
10 Annular seal
11 Extension
12 Seal

What is claimed is:

1. A cooling module for batteries of an electric or hybrid vehicle, the cooling module comprising:
a coolant supply line;
a coolant discharge line; and
a plurality of flat tubes arranged side by side, between which there is space for batteries to be cooled, each of the flat tubes being connected to the coolant supply line and the coolant discharge line;
wherein the flat tubes each carry connectors, and wherein the coolant supply line and the coolant discharge line are each assembled from a plurality of line segments connected by a connector of one of the flat tubes to one of the connectors of an adjacent flat tube.

2. The cooling module according to claim 1, wherein the flat tubes are corrugated.

3. The cooling module according to claim 1, wherein the connectors are attached to end pieces, which are attached to ends of the flat tubes.

4. The cooling module according to claim 3, wherein the flat tubes carry the end pieces with the connectors at opposite ends, and the flat tubes run between the coolant supply line and the coolant discharge line.

5. The cooling module according to claim 3, wherein the flat tubes carry the end pieces with the connectors at only one end, and the coolant supply line and the coolant discharge line run on the same side of the flat tubes, wherein the flat tubes each form two channels running side by side.

6. The cooling module according to claim 3, wherein the end pieces each carry the connectors for the coolant supply line and the coolant discharge line.

7. The cooling module according to claim 6, wherein the line segments are connected to the connectors by a push-fit connection or a plug-in connection.

8. The cooling module according to claim 7, wherein the line segments are inserted into the connectors.

9. The cooling module according to claim 7, wherein the end pieces have an inner part surrounded by the connector and projecting into the line segments.

10. The cooling module according to claim 9, wherein the inner part carries an annular seal.

11. The cooling module according to claim 6, wherein the connectors are inserted into the line segments.

12. The cooling module according to claim 11, wherein the line segments carry annular seals on their insides that are pressed against an outside of the connectors.

13. The cooling module according to claim 11, wherein each line segment carries an annular seal that is a single piece that is pressed against both connectors protruding into that line segment.

14. The cooling module according to claim 1, wherein a spacer strip is arranged between adjacent flat tubes, and, between itself and each of the two adjacent flat tubes, limits spaces for the batteries that are to be cooled.

15. The cooling module according to claim 14, wherein the spacer strips have an extension, with which they abut against the coolant supply line and/or the coolant discharge.
